(19) United States
(12) Patent Application Publication
(10) Pub. No.: US 2006/0114940 A1
(43) Pub. Date: Jun. 1, 2006

(54) Sensor network for transmitting data and data transmitting method thereof

(75) Inventors: Sung-Woo Cho, Seoul (KR); Chun-Soo Park, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/285,293

(22) Filed: Nov. 23, 2005

(30) Foreign Application Priority Data
Nov. 26, 2004 (KR) 2004-98049

(51) Int. Cl. H04J 3/00

(52) U.S. Cl. 370/498; 370/345; 370/347; 370/335

(57) ABSTRACT

Disclosed are a sensor network for transmitting data and a data transmitting method thereof. The sensor network includes one or more sensor nodes for collecting target data and transmitting the collected target data at an allocated sub-time slot among sub-time slots constituting each time slot corresponding to the collected target data, and a gathering node for allocating for the sensor nodes a sub-time slot for each of the time slots, and receiving the collected target data transmitted by the sensor nodes. Data transmission by bits reduces power consumption and does not require additional information transmission to prevent data collision. Therefore, power consumption is minimized and a plurality of sensor nodes possibly transmit data at one time, accordingly shortening transmission time.

### CROSS-REFERENCE TO RELATED APPLICATIONS

This application claims benefit under 35 U.S.C. § 119(a) of Korean Patent Application No. 2004-98049, filed Nov. 26, 2004, the entire contents of which are incorporated herein by reference.

### BACKGROUND OF THE INVENTION

1. Field of the Invention

The present invention relates to a sensor network for transmitting data and data transmitting method thereof. More particularly, the present invention relates to a sensor network for transmitting data and a data transmitting method thereof capable of collecting data at a sensor network having sensor nodes receiving and transmitting collected target data.

2. Description of the Related Art

A general mobile telecommunication system receives and transmits data between a mobile element and a base station. The mobile element and the base station receive and transmit data, not via other mobile elements or nodes, but directly. However, a sensor network uses other sensor nodes when transmitting data of a sensor node to a sink node.

A structure of a general sensor network will be described with reference to FIG. 1. As shown in FIG. 1, the sensor network has a sink node and a plurality of sensor nodes. Although FIG. 1 shows only one sink node, the sensor network can be composed of 2 or more sink nodes.

The sensor node collects data on target areas set by a designated user. Information on target areas collected by the sensor node may include, for example, ambient temperature or humidity, object movement, and gas leakage.

The sensor node transmits data of collected information at the target area to the sink node. The sink node receives data sent by sensor nodes of the sensor network. A sensor node within a predetermined distance of the sink node directly transmits data to the sink node. However, a sensor node that is beyond a predetermined distance transmits collected data to the adjacent sensor nodes, instead of directly sending the data to the sink node.

FIG. 2 shows one part of the sensor network. Referring to FIG. 2, one part of the sensor network has 5 sensor nodes, that is node 1, node 2, node 3, node 4, and node 5, which is the gathering node. In addition, the gathering node (node 5), and node 1, node 2, node 3 and node 4 are placed within 1-hop distance.

The gathering node is not fixed as a particular one of the node sensors but is changeable according to the situation. In the entire sensor network, one or more gathering nodes may exist. As shown in FIG. 2, node 5, which has the highest position of the 5 sensor nodes, becomes the gathering node and the gathering node collects data transmitted by the rest of the sub-sensor nodes, that is, node 1, node 2, node 3 and node 4. Node 1, node 2, node 3 and node 4 transmit data to the gathering node. That is, node 1 collects data 10 at a target, with node 2 for data 9, node 3 for data 16, node 4 for data 11, and transmits each collected data to the gathering node.

As described above, a part of the sensor network has one gathering node and four sensor nodes, and each sensor node collects data with a predetermined integer number, as one example. The sensor network clearly includes one or more gathering nodes and the plurality of sensor nodes and each sensor node can collect data with values other than the integer numbers.

As described above, a sensor node that is not within a predetermined distance transmits data using adjacent sensor nodes, to minimize power consumption for data transmission. That is, the distance between the sink node and the sensor node, and the power needed for the sensor node to transmit data to the sink node, are generally proportional to each other.

Accordingly, a sensor node that is not within a predetermined distance from the sink node, transmits collected data using a plurality of sensor nodes, to minimize power consumption required for data transmission.

However, in the conventional sensor network, a sensor node transmits its collected data to an adjacent sensor node, that is, to a gathering node, using the frame-based Time Division Multiple Access (TDMA).

Hereinafter, a conventional frame-based TDMA method will be described in detail with reference to FIGS. 3A and 3B which are provided to explain a conventional data collecting method. FIG. 3A is a frame structure to which data collected by the sensor node is added. The frame includes physical layer (PHY) by use of preamble, header indication data information, data collected by a sensor node and Frame Check Sequence (FCS) for error checks.

FIG. 3B shows the conventional TDMA method, with a frequency band periodically divided in predetermined time intervals. Such predetermined time intervals are called a ‘time slot’, with each time slot allocated at node 1, node 2, node 3 and node 4. Node 1, node 2, node 3 and node 4 occupy each allocated time slot during each divided time and transmit each frame with each collected data 10, 9, 16 and 11 included, to the gathering node.

The gathering node collects data transmitted from the sensor node allocated to each time slot. At this time, frame collision might occur by synchronization error of exceeding an allocated time slot when transmitting the frame and in this case, this problem is solved through Carrier Sense Multiple Access (CSMA) or Collision Avoidance (CA) protocol.

Accordingly, sensor nodes transmit complete frames to transmit a small amount of data, and this can cause increased power consumption for data transmission. One node allocated during a time slot can transmit data, to lead to extended transmission time. In addition, to prevent collision, sensor nodes are required to transmit additional information such as carrier information, which can bring about power waste.

### SUMMARY OF THE INVENTION

An aspect of the present invention is to solve at least the above problems and/or disadvantages and to provide at least the advantages described below. Accordingly, an aspect of the present invention is to provide a sensor network for transmitting data and data transmitting method thereof capable of collecting data, by enabling sensor nodes to transmit by bits instead of by frame.

Another aspect of the present invention is to provide a sensor network for transmitting data and a data transmitting method thereof capable of collecting data, by enabling a plurality of sensor nodes to transmit data at the same time.

Yet another aspect of the present invention is to provide a sensor network which does not need additional information transmission, to avoid possible collision during transmitting data.

In order to achieve the above-described aspects of the present invention, there is provided a sensor network comprising one or more sensor nodes for collecting target data and transmitting the collected target data at an allocated sub-time slot among sub-time slots constituting each time slot corresponding to the collected target data; and a gathering node for allocating for the sensor nodes with the sub-time slot for each of the time slots, and receiving the collected target data transmitted by the sensor nodes.

Collectable target data are divided into not less than two groups by the time slot and the time slot comprises a plurality of sub-time slots corresponding to the divided groups.

The gathering node is one of the sensor nodes, and has a higher position than the sensor nodes.

The gathering node classifies the data into not less than two groups, and collects data with lower value than the groups as a low data group, while collecting data with higher value than the groups as a high data group.

The sensor nodes are placed within 1-hop distance from the gathering node.

The gathering node allows a predetermined error to the sub-time slot.

The gathering node corrects the error by widening intervals of the sub-time slot.

A data transmitting method of a sensor network which includes a sensor node for transmitting collected target data and a gathering node for receiving the data transmitted by the sensor node comprises steps of transmitting collected target data at a sub-time slot allocated among sub-time slots constituting each time slot corresponding to the collected target data at a sensor network including the sensor node for transmitting collected target data and the gathering node for receiving the data transmitted by the sensor node, and allocating the sub-time slot to the sensor node for each time slot and receiving the collected target data transmitted by the sensor node.

The data transmitting method of a sensor network which includes a sensor node for transmitting collected target data and a gathering node for receiving the data transmitted by the sensor node further comprises steps of classifying the collectable target data into at least two groups and dividing each of the time slot corresponding the classified groups into a plurality of sub-time slots.

The gathering node is one of the sensor nodes and has a higher position than the sensor nodes.

The data is classified into at least two groups and collected into a low data group if lower than the groups, and collected to a high data group if higher than the groups.

The sensor node is placed within 1-hop distance from the gathering node.

A predetermined error is allowed at the sub-time slot.

The error is corrected by widening intervals of the sub-time slot.

### BRIEF DESCRIPTION OF THE DRAWING FIGURES

The above aspect and other features of the present invention will become more apparent by describing in detail exemplary embodiments thereof with reference to the attached drawing figures, wherein;

FIG. 1 is a general sensor network,

FIG. 2 is a part of a sensor network,

FIGS. 3A and 3B are provided for explaining a conventional data collecting method,

FIG. 4 shows a view provided for explaining a TDMA method, a data collecting method of the present invention,

FIG. 5 is a view provided for explaining a data collecting method of a sensor network according to an embodiment of the present invention,

FIG. 6 is a view provided for explaining a data collecting method of a sensor network according to another embodiment of the present invention,

FIG. 7A displays an example of synchronization error occurring upon data collection, and

FIG. 7B is a view provided for explaining synchronization error correction and compensation according to an embodiment of the present invention.

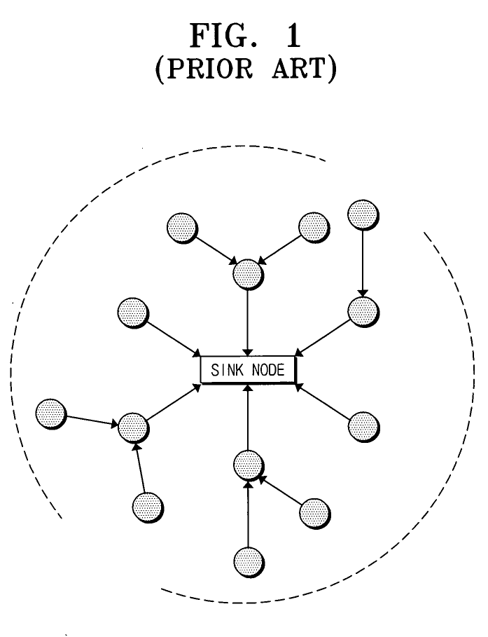

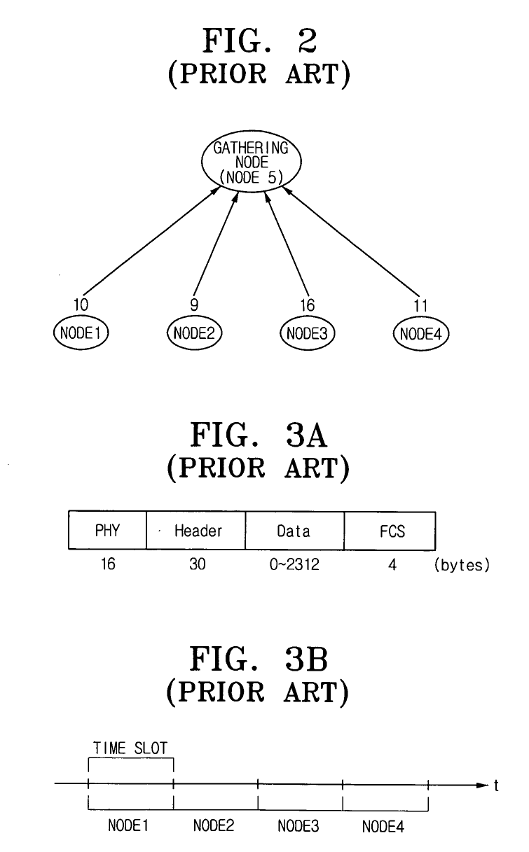

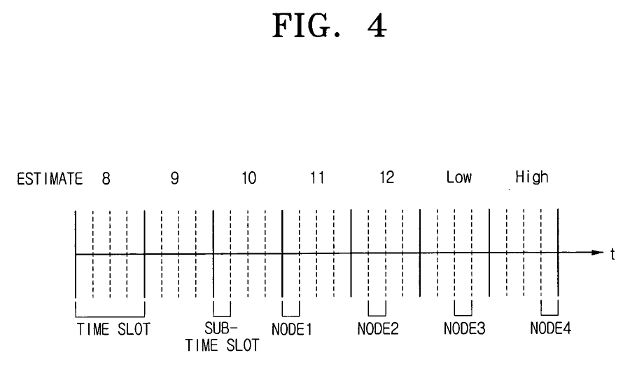

### DETAILED DESCRIPTION OF THE EXEMPLARY EMBODIMENTS

Hereinafter, an exemplary embodiment of the present invention will be described in detail with reference to the accompanying drawing figures.

In the following description, the same drawing reference numerals are used for the same elements even in different drawings. The matters defined in the description such as a detailed construction and elements are only provided to assist in a comprehensive understanding of the invention. Thus, it is apparent that the present invention can be carried out without those defined matters. Also, well-known functions or constructions are not described in detail since such description would obscure the invention in unnecessary detail.

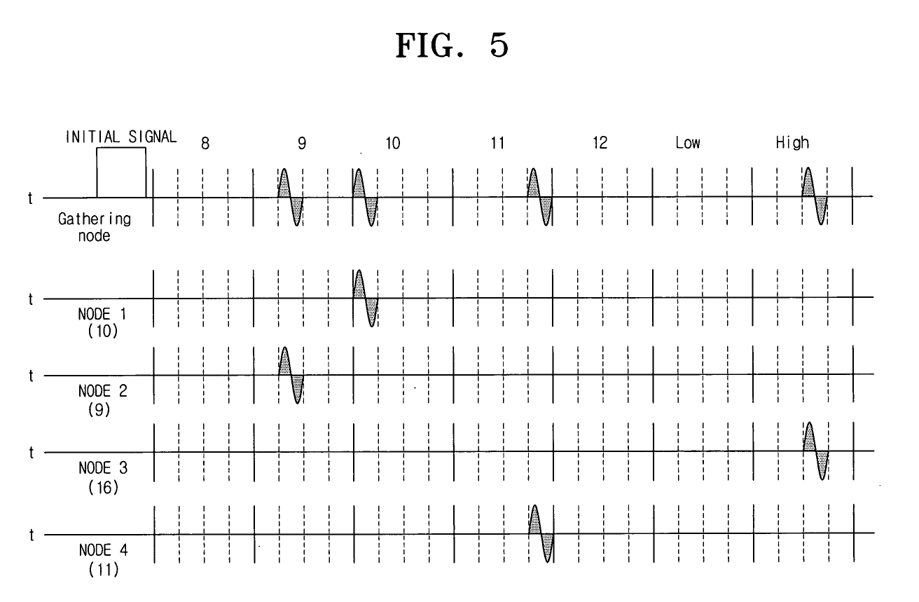

FIG. 4 is a view provided for explaining a TDMA method, a data collecting method of the present invention.

Referring to FIG. 4, frequency bands are composed of a time slot for each data estimate, that is, a low time slot and a high time slot. Each time slot is composed of a number of sub-time slots equal to the number of sensor nodes.

In detail, as an example, a gathering node (node 5) sets groups of data estimates. In consideration of correlation, the gathering node sets the groups of data estimates as 8, 9, 10, 11, and 12. The groups of data estimates may have a wider or narrower range, according to the correlation. In the case of temperature or humidity data, a decimal point may exist, but this will increase the number of time slots corresponding to the set groups, to cause overload of data transmission. In addition, it can increase the time required for data transmission. Accordingly, the gathering node may preferably set a group 8 for data estimates ranging from 8 to 8.9.

Likewise, the gathering node sets groups including two or more data estimates for the other data estimates.

The gathering node sets all the data with smaller value than the lowest data estimate 8 as a low data group, and sets all the data with bigger value than the highest data estimate 12 as a high data group. The low data group includes data with smaller values than the lowest data group of the set data estimates, while the high data group includes data with bigger values than the highest group of the set data estimates.

When the data estimate groups are set, the gathering node divides the frequency bands into each time slot corresponding to each data estimate, that is, to low data and high data. Accordingly, the frequency bands have seven time slots including not only five time slots corresponding to data estimates ranging from 8 to 12 but also two time slots corresponding to low data and high data.

As described above, the gathering node divides the frequency bands, such that one time slot corresponds to one data estimate group, but one time slot may correspond to one or more data estimate groups.

When the time slots are divided according to data estimates, the gathering node divides each time slot into the number of sensor nodes, that is, into the number of sub-time slots equal to the number of lower sensor nodes (node 1, node 2, node 3, and node 4) to transmit data to each of the sensor nodes. Accordingly, one time slot has four sub-time slots. Since the gathering node divides the time slot into the number of sensor nodes, if there are a plurality of sensor nodes, there are accordingly a plurality of sub-time slots included in one time slot.

All of the four sensor nodes can transmit data to the gathering node at one time during one time slot, accordingly reducing time required for data collecting and quickening data collecting speeds.

The sensor nodes transmit a Routing Request (RREQ) message to the gathering node, to set a routing path for transmitting collected data to the gathering node. The gathering node receives the Routing Request Message, to be informed of the address and ID of the lower sensor nodes and their number. Accordingly, the gathering node can divide one time slot into a number of sub-time slots to equal the number of lower sensor nodes.

When the sub-time slots are divided, the gathering node sets the sensor node to collect data at each sub-time slot. The sensor nodes transmit collected data to the gathering node, at each allocated sub-time slot. Node 1 is allocated with a first sub-time slot among time slots and transmits 1 bit of data to the gathering node during the first allocated sub-time slot. Node 2 is allocated with a second sub-time slot and transmits 1 bit of data to the gathering node during the second allocated sub-time slot. Node 3 is allocated with a third sub-time slot among time slots and transmits 1 bit of data to the gathering node during the third allocated sub-time slot. Node 4 is allocated with a fourth sub-time slot among time slots and transmits 1 bit of data to the gathering node during the fourth allocated sub-time slot.

As described above, the gathering node allocates each sub-time slot to sensor nodes in regular order. However, it is possible to allocate sub-time slots according to the distance of each sensor node or in the order of data arrival by each sensor node.

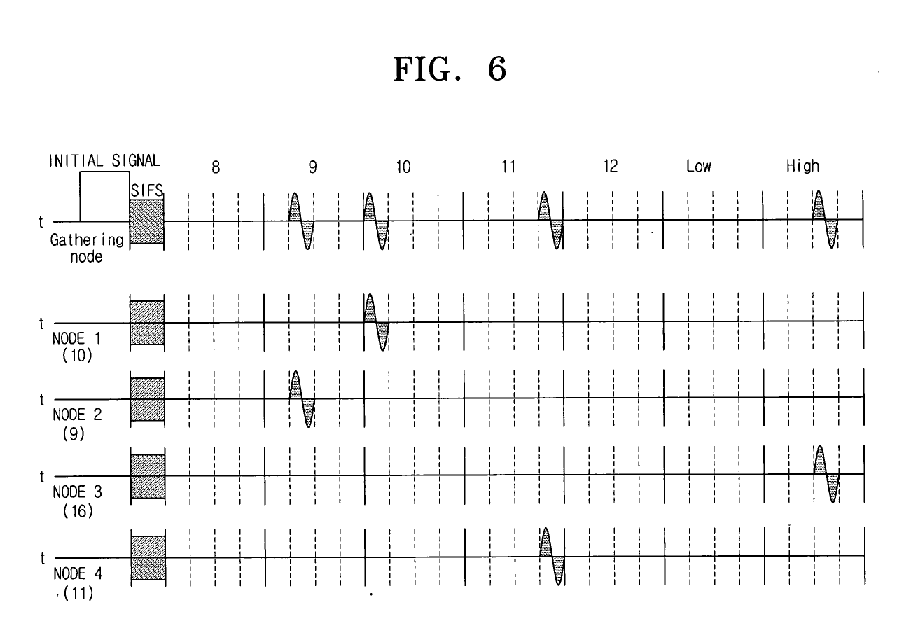

FIG. 5 is provided to explain a data transmitting method of a sensor network according to an embodiment of the present invention.

Referring to FIG. 5, the data transmitting method of a sensor network according to an embodiment of the present invention employs both the above described TDMA method and Amplitude Shift Keying (ASK) or On-off Keying. The ASK is a modulation method with a binary number's amplitude varied according to data. As described above, a predetermined amplitude of signal exists in case that collected data exists, while the predetermined amplitude of signal does not exist in case that the collected data does not exist.

Referring to FIG. 4, the gathering node, when prepared to collect data, transmits an initial signal to each sensor node. The initial signal is for obtaining data transmission synchronization of each sensor node, including the number of sensor nodes for data collection, range of data estimates, the number of time slots, and the number of sub-time slots.

Node 1 collects data 10. Based on the initial signal transmitted from the gathering node, node 1 transmits collected data 10 by bits during the first sub-time slot allocated to the node 1 of the time slot, where the bits correspond to the data 10, to the gathering node. The gathering node collects data 10 from node 1 during the first sub-time slot allocated to node 1 of the time slot.

Node 2 collects data 9. Based on the initial signal transmitted from the gathering node, node 2 transmits collected data 9 by bits during the second sub-time slot allocated to the node 2 of the time slot, where the bits correspond to the data 9, to the gathering node. The gathering node collects data 9 from node 2 during the second time slot allocated to node 2 of the time slot.

Node 3 collects data 16. Based on the initial signal transmitted from the gathering node, node 3 by bits transmits data 16, which is more than a range of data estimates, to the gathering node during the third sub-time slot allocated to the node 3 of the time slot, where the bits correspond to high data. The gathering node collects data 16 from node 3 during the third sub-time slot allocated to the node 3 of the time slot, and data 16 corresponds to high data.

Node 4 collects data 11. Based on the initial signal transmitted by the gathering node, node 4 by bits transmits collected data 11 to the gathering node during the fourth sub-time slot allocated to the node 4 of the time slot, where the bits correspond to the data 11. The gathering node collects data 11 from node 4 during the fourth sub-time slot allocated to the node 4 of time slot.

Accordingly, simultaneous bits-transmission of data collected by node 1, node 2, node 3 and node 4 to the gathering node, shortens the data transmission time and reduces the data transmission rate, resulting in the potential for decreasing power consumption.

TABLE 1

| | Power Used By | Power Used By A Data |
|---|---|---|
| | Conventional Data | Collecting Method of |
| | Collecting Method | The Present Invention |
| Number of Nodes = 5 | 0.11454 | 0.05043 |
| Number of Nodes = 6 | 0.14097 | 0.06053 |
| Number of Nodes = 7 | 0.16740 | 0.07063 |

Table 1 displays power consumptions obtained by experiment in a 10 meter-wide and 10 meter-long sensor network space for a comparison of the conventional data collecting method and the data collecting method according to an embodiment of the present invention. Referring to Table 1, it is indicated that the data collecting method according to an embodiment of the present invention leads to approximately 60% reduction of power consumption compared to the conventional data collecting method.

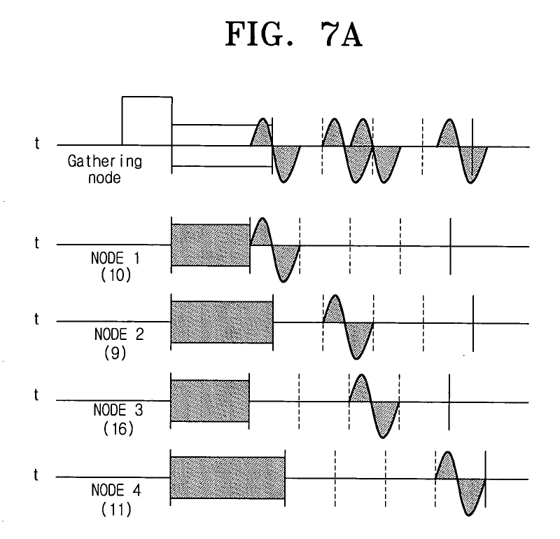

FIG. 6 is a view of a data collecting method of a sensor network according to another embodiment of the present invention.

Referring to FIG. 6, Short Inter Frame Space (SIFS) is used to define minimal waiting time until data transmission operation, after each node senses a need for preparation for data transmission and is thus completed with preparation for synchronization. SIFS is used in the Institute of Electrical and Electronics Engineers (IEEE) 802.11 standard, which is wireless telecommunication network protocol, allowing any possible errors during data transmission in predetermined time intervals.

Specifically, if the gathering node transmits an initial signal to each sensor node, each sensor node synchronizes data transmission to transmit to the gathering node collected data based on the initial signal. At this time, the gathering node and each sensor node are placed together within a 1-hop distance, but not in constant intervals with each other. Accordingly, a sensor node remote from the gathering node requires more time for receiving the initial signal than another sensor node closer to the gathering node.

Therefore, there are possibly different points when sensor nodes transmit data to the gathering node or the time when the transmitted data reach the gathering node. In order to prevent such cases, SIFS is provided to allow any possible data transmission errors. On the assumption that SIFS allows errors at maximum up to 10% of a sub-time slot, for an example, the gathering node regards as data collected in a first sub-time slot, data collected in the first sub-time slot and 10% of a second sub-time slot.

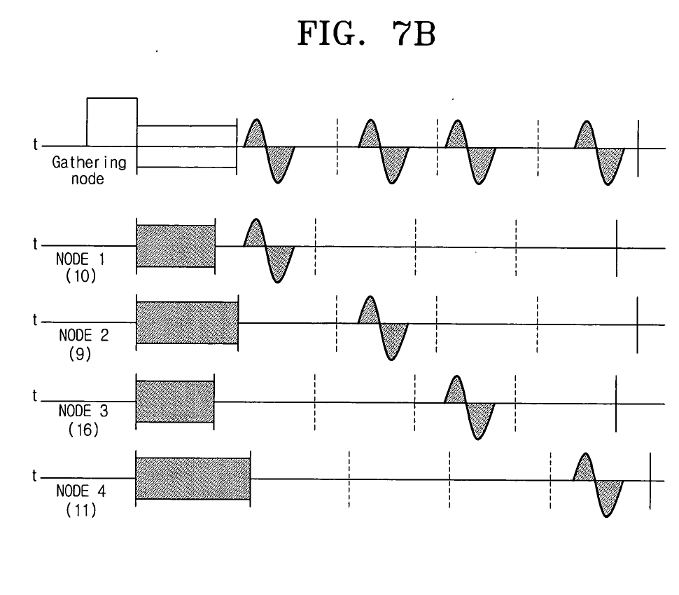

FIG. 7A displays an example of synchronization errors occurring in data collection. Referring FIG. 7A, in a sensor network for receiving data by use of a Radio Frequency (RF) module, synchronization errors may occur during the mode shifting process between receiving mode and transmitting mode in order for the gathering node and the sensor nodes to receive and transmit data.

The gathering node is shifted to the receiving mode for collecting data transmitted from each sensor node from the transmitting mode for transmitting the initial signal to each sensor node, while respective sensor nodes are changed to the transmitting mode for transmitting collected data at the gathering mode from the receiving mode for receiving the initial signal transmitted from the gathering mode.

At this time, synchronization errors may occur and accordingly, at the point when data transmitted in an allocated sub-time slot by each sensor node is received at the gathering node, the data exceeds its allocated sub-time slot and enters into a sub-time slot allocated to another sensor node. In addition, data may overlap in case that data is transmitted to the next sub-time slot.

As described in FIG. 7A, synchronization errors cause the data transmitted by each sensor node to exceed the allocated sub-time slot. More specifically, quicker in mode shifting than other nodes, node 1 and node 3 transmit data to the gathering node earlier than others and the synchronization errors take place. Accordingly, the data transmitted to the gathering node by node 1 and node 3 exceeds its allocated sub-time slot and reaches the front sub-time slot. Node 2 transmits data in the duration of a second slot, which is allocated in accordance with synchronization of node 2 to the gathering node. Node 4 is slower in mode shifting than other nodes and synchronization errors occur. Accordingly, the data transmitted to the gathering node by node 4 exceeds the allocated fourth sub-time slot and reaches the front sub-time slot. In addition, synchronization errors cause the data transmitted to the gathering node by node 3 to exceed the allocated third sub-time slot and overlaps with the data transmitted to the gathering node by node 2 during the second sub-time slot.

Thus, error detection for data transmission of each sensor node is enabled, without requiring any special detection process, to see collected data at each sub-time slot. Additionally, it is detected which data has synchronization errors.

FIG. 7B is a view provided to explain synchronization error correction according to an embodiment of the present invention.

As shown in FIG. 7B, it is possible to correct synchronization errors by widening intervals between each time slot, that is, between each sub-time slot, in case of occurrence of synchronization errors. Specifically, in consideration of the time needed for shifting a telecommunication mode, the gathering node widens intervals between each time slot and transmits information on the widened intervals. After receiving the information on the widened intervals between sub-time slots, each sensor node transmits data to the widened corresponding sub-time slots, to correct synchronization errors.

In the embodiments of the present invention as described above, a data transmitting method of a sensor network located within 1-hop distance was explained as an example. However, an entire data transmitting method of a sensor network can also be described by hierarchically expanding the data transmitting method into several hops.

According to exemplary embodiments of the present invention as explained above, data transmission by bits decreases power consumption and does not require transmission of additional information for data collision prevention. Accordingly, power consumption is minimized and a plurality of sensor nodes are capable of transmitting data at one time, shortening transmission time.

While the invention has been shown and described with reference to certain embodiments thereof, it will be understood by those skilled in the art that various changes in form and details may be made therein without departing from the spirit and scope of the invention as defined by the appended claims.

What is claimed is:

1. A sensor network comprising:
one or more sensor nodes that collect target data and transmit the collected target data at an allocated sub-time slot among sub-time slots constituting each time slot corresponding to the collected target data; and
a gathering node that allocates the sensor nodes with the sub-time slot for each of the time slots, and receives the collected target data transmitted by the sensor nodes.

2. The sensor network of claim 1, wherein collectable target data are divided into not less than two groups by the time slot and the time slot comprises a plurality of sub-time slots corresponding to the divided groups.

3. The sensor network of claim 1, wherein the gathering node is one of the sensor nodes, and has a higher position than other sensor nodes.

4. The sensor network of claim 1, wherein the gathering node classifies the data into not less than two groups, and collects data with lower value than the groups as a low data group, and collecting data with higher value than the groups as a high data group.

5. The sensor network of claim 1, wherein the sensor nodes are placed within 1-hop distance from the gathering node.

6. The sensor network of claim 1, wherein the gathering node allows a predetermined error to the sub-time slot.

7. The sensor network of 6, wherein the gathering node corrects the error by widening intervals of the sub-time slot.

8. A data transmitting method of a sensor network which includes a sensor node for transmitting collected target data and a gathering node for receiving the data transmitted by the sensor node, the data transmitting method comprising:
transmitting, from the sensor node, the collected target data at a sub-time slot allocated among sub-time slots constituting each time slot corresponding to the collected target data; and
allocating the sub-time slot to the sensor node for each time slot and receiving, at the gathering node, the collected target data transmitted by the sensor node.

9. The data transmitting method of claim 8, further comprising:
classifying the collectable target data into at least two groups; and
dividing each of the time slots into a plurality of sub-time slots corresponding to the classified groups.

10. The data transmitting method of claim 8, wherein the gathering node is one of the sensor nodes and has a higher position than other sensor nodes.

11. The data transmitting method of claim 8, wherein the data is classified into at least two groups and data collected with a value lower than the groups is collected into a low data group, and data collected with a value higher than the groups is collected to a high data group.

12. The data transmitting method of claim 8, wherein the sensor node is placed within 1-hop distance from the gathering node.

13. The data transmitting method of claim 8, wherein a predetermined error is allowed at the sub-time slot.

14. The data transmitting method of claim 13, wherein the error is corrected by widening intervals of the sub-time slot.
